(19) United States
(12) Patent Application Publication
(10) Pub. No.: US 2012/0258204 A1
(43) Pub. Date: Oct. 11, 2012

(54) Cold-Brew Green Tea Composition and Method of Brewing Cold-Brew Green Tea

(76) Inventors: Kazushi Tsuji, Osaka (JP); Kanji Sagawa, Osaka (JP)

(21) Appl. No.: 13/079,829

(22) Filed: Apr. 5, 2011

(51) Int. Cl. A23F 3/18; B65B 29/02; A47J 31/06

(52) U.S. Cl. 426/77; 426/597; 99/295

(57) ABSTRACT

The present application is directed to various embodiments of cold-brew green tea compositions, methods of preparing a cold-brew green tea beverage, an infusion bag for cold brewing green tea, and a green tea cold brewing system. In at least one embodiment, the cold-brew green tea composition comprises a mixture of green tea leaf pieces and powdered green tea leaves. Mixing the cold-brew green tea composition in chilled water may produce a green tea beverage having a high concentration of catechins.

### BACKGROUND

The present invention is directed to cold-brew green tea compositions, and methods and systems for preparing cold-brew green tea beverages.

References to green tea use date back at least 5000 years in Chinese literature. European traders introduced green tea to the West in the sixteenth century, and it quickly became an important commodity. Green tea is made from leaves of the Camellia senesis plant that have undergone minimal oxidation during processing. Processing of tea is the method in which the picked leaves are dried to form the tea that is used for brewing. One step of the drying process is the oxidation step (although some oxidation may occur during the wilting step immediately following plucking of the leaves from the plant). Green teas may have as little as 5 percent oxidation, while black teas generally have 100 percent oxidation.

Brewing of tea, also known as steeping, involves placing the tea in some form of container or bag, then placing the container in water. The temperature of the water may vary depending on the quality of the tea leaves and the desired flavor of the resulting tea beverage. The brewing time is also related to tea leaf quality and desired flavor, and may last many minutes.

Green tea is widely recognized for its healthy benefits, ranging from an aid for weight loss to a cancer fighting agent. These benefits are believed to be related to the high antioxidant content of green tea beverages. These antioxidants may take the form of polyphenol catechins, and in particular epigallocatechin gallate (EGCG). Other phenol catechins that may be found in green tea include gallocatechin, epigallocatechin, and epicatechin. The growing body of scientific evidence that points to the beneficial effects of green tea consumption has helped stimulate annual world tea production from just under 3 million tonnes in 2000 to nearly 3.9 million tonnes in 2007.

### SUMMARY

Various embodiments of the present invention are directed to cold-brew green tea compositions, methods of preparing a cold-brew green tea beverage, an infusion bag for cold brewing green tea, and a green tea cold brewing system. In at least one embodiment, the cold-brew green tea composition comprises a mixture of green tea leaf pieces and powdered green tea leaves. Mixing the cold-brew green tea composition in chilled water may produce a green tea beverage having a high concentration of catechins.

### BRIEF DESCRIPTION OF THE DRAWINGS

FIG. 1 is an illustration of a cold-brew green tea infusion bag adapted to be readily inserted through the mouth of a standard water bottle according to various embodiments of the present invention.

FIG. 2 is a graph comparing the taste of various cold-brew green tea beverages according to various embodiments of the present invention.

FIG. 3 is a graph comparing the color of various cold-brew green tea beverages according to various embodiments of the present invention

### DETAILED DESCRIPTION

Various embodiments of the present invention are directed to cold-brew green tea compositions, methods of preparing a cold-brew green tea beverage, an infusion bag for cold brewing green tea, and a green tea cold brewing system. In at least one embodiment, the cold-brew green tea composition comprises a mixture of green tea leaf pieces ranging in size from about 2 millimeters (mm) to about 6 mm, and powdered green tea leaves ranging in size from about 20 micrometers (μm) to about 40 μm. The green tea leaf pieces and powder may be mixed in a ratio ranging from about 2 parts pieces to 1 part powder (2:1 ratio) to about 10 parts pieces to 1 part powder (10:1 ratio). Mixing the cold-brew green tea composition in chilled water at a temperature of about 10 degrees Celsius (° C.) may produce a concentration of catechins in the water ranging from about 0.1 milligrams/milliliter (mg/ml) to about 0.8 mg/ml after about 1 minute of mixing.

Various embodiments of the present invention may include a method for preparing a cold-brew green tea beverage. Green tea leaf pieces may be prepared by reducing green tea leaves into pieces ranging in size from about 2 mm to about 6 mm. Green tea leaf powder may be prepared by reducing green tea leaves into particles ranging in size from about 20 μm to about 40 μm. The green tea leaf pieces and green tea leaf powder may be combined in a ratio ranging from about 2:1 to about 10:1, respectively, to form a green tea mixture. The green tea mixture may then be exposed to water having a temperature of about 10° C. for about 1 minute to produce a concentration of catechins in the water ranging from about 0.1 mg/ml to about 0.8 mg/ml.

Further various embodiments of the present invention may include a green tea cold brewing system. The green tea cold brewing system may be comprised of an infusion bag made of at least one nonwoven fabric having a mass per unit area ranging from about 10 grams/square meter (g/m²) to about 30 g/m², a ventilation rate ranging from about 150 milliliters/centimeter-second (ml/cm-sec) to about 450 ml/cm-sec, and a filtering rate of about 1.5 seconds/500 milliliters (sec/500 ml) to about 2.5 sec/500 ml. The infusion bag may be sized such that the infusion bag may be readily inserted through a mouth of a standard water bottle. The infusion bag may contain a mixture of green tea pieces ranging in size from about 2 mm to about 6 mm, and green tea powder ranging in size from about 20 μm to about 40 μm. A ratio of green tea pieces to green tea powder may range from about 2:1 to about 10:1. A total amount of the green tea mixture in the infusion bag may range from about 1 g to about 4 g.

Still further various embodiments may include a cold-brew green tea infusion bag. The infusion bag may be made of at least one non-woven fabric having a mass per unit area of about 10 g/m² to about 30 g/m², a ventilation rate ranging from about 150 ml/cm-sec to about 450 ml/cm-sec, and a filtering rate of about 1.5 sec/500 ml to about 2.5 sec/500 ml. A width of the infusion bag may range from about 20 mm to about 40 mm to allow the infusion bag to be readily inserted through a mouth of a standard water bottle. The infusion bag may have a length selected to provide a green tea capacity sufficient to produce a cold-brew green tea beverage of satisfactory taste after a period of 1 minute of mixing the bag with the water at less than or equal to about 10° C. in the water bottle.

Green tea is widely recognized for its healthy benefits, ranging from an aid for weight loss to a cancer fighting agent. These benefits are believed to be related to the high antioxidant content of green tea beverages. These antioxidants may take the form of polyphenol catechins, and in particular epigallocatechin gallate (EGCG). Other phenol catechins that may be found in green tea include gallocatechin, epigallocatechin, and epicatechin. The growing body of scientific evidence that points to the beneficial effects of green tea consumption has helped stimulate annual world tea production from just under 3 million tonnes in 2000 to nearly 3.9 million tonnes in 2007.

However, despite the benefits of drinking green tea and the push within the U.S. for a healthier lifestyle, green tea usage in the U.S. is one of the lowest in the world. A study in 2005 revealed that green tea is the least favorite non-alcoholic drink in the U.S., with only 15 percent of respondents indicating that they drink green tea on a typical day. While there are many explanations for this lack of green tea consumption, one of the most prevalent may simply be the lack of convenience of hot tea products.

Green tea is typically brewed in hot water to release the flavor and aroma from the tea leaves. Given the generally fast pace of the American lifestyle, many people do not feel they have the time to boil water and steep the tea leaves in order to get a single cup of tea. Americans are more conditioned to simply open a bottle or quickly mix a powder or liquid in water to obtain a beverage. Thus, green tea is consumed only when there is time to carry out the steps of hot brewing. Cold brewing green tea has traditionally been difficult because of the length of time necessary to product a beverage with satisfactory taste. Currently available green tea bags require a brewing time of as much as two hours in cold water to produce a flavorful drink. The present invention solves this problem by providing a cold-brew green tea beverage that takes about 1 minute or less to prepare a beverage with satisfactory flavor and color using cold water.

Various embodiments of the present invention are comprised of a mixture of green tea pieces and green tea powder. After harvesting, the green tea leaves may range in size from about 10 mm to about 30 mm in length. Experimentation has shown that cold brewing with leaves of this size required an unacceptably long period of time to produce a beverage of satisfactory flavor and color. Reducing the size of the tea leaf pieces increases the surface area of the tea leaves exposed to the water, thus reducing the cold brewing time. Further experimentation showed that reducing the size of the green tea leaf pieces to about 2 mm to about 6 mm increased the speed of the cold brewing process by about 4-5 times that of full-size green tea leaves. The green tea pieces may be formed by chopping, tearing, grinding, or any other method known in the art.

Further experimentation revealed that providing a mixture of green tea leaf pieces and green tea leaf powder substantially increases the cold brewing rate, and enables a flavorful and colorful green tea drink to be produced in less than about 1 minute. Various ratios of green tea leaf pieces to green tea leaf powder were used to determine ratios that provide the desired combination of reduced cold brewing time, flavor, and color. If the ratio is too high in green tea leaf powder, the flavor of the green tea beverage tends to be too strong. If the ratio is too high in green tea leaf pieces, the flavor may be better controlled but cold brewing time increases. It was found that varying the ratio of green tea leaf pieces to green tea leaf powder from about 2:1 to about 10:1 provided the desired cold brewing time of less than 1 minute while maintaining a rich taste and color.

It has also been found that roasting the tea leaves as part of the drying process or in addition to the drying process results in further development of a rich flavor during the cold brewing process. It is hypothesized that the roasting process allows flavors to be released from the tea leaves in cold water much in the same way as hot water releases flavor from the leaves during hot brewing. Experimentation with various mixtures of roasted green tea leaves and unroasted green tea leaves were conducted for producing the green tea pieces. It was found that using a substantial majority of roasted green teas to make the green tea leaf pieces resulted in an overly bitter tea beverage. Using a substantial minority of roasted green tea leaves had little result on the cold brewing process. A mixture of about half roasted green tea leaves and half unroasted green tea leaves to make the green tea leaf pieces was found to balance the speed of the cold brewing process and limit the bitterness of the tea beverage.

Green tea leaves contain a variety of chemical compounds. Many of these compounds may be contained in a liquid (e.g., water) beverage made from green tea leaves. As discussed previously, these compounds may include catechins. One measure of the extent of the brewing processes is the concentration of catechins in the beverage. The extent of brewing may be dependent on a number of factors, including the temperature of the liquid, surface area of green tea exposed to the liquid, and brewing time. At temperatures below about 10° C., brewing rates for green tea are generally very slow. However, the unique combination of green tea pieces and green tea powder of the present invention greatly increases the brewing rate when the temperature of the water is less than or equal to about 10° C. The brewing rate of the present invention is such that a concentration of catechins in the liquid ranges from about 0.1 mg/ml to about 0.8 mg/ml after about 1 minute of contact of the green tea pieces and green tea powder with the liquid.

Other measures of the degree of extraction include analysis of the taste and color of the tea. Panelist experienced in the quality of brewed tea taste and color evaluated the presented invention after a variety of brewing times. The panelist determined high-quality taste and color were achieved with the present invention after mixing with water at a temperature of less than or equal to about 10° C. in about 1 minute. Further details are presented in the example below.

Various embodiments of the present invention comprise an infusion bag for cold brewing a mixture of green tea pieces and green tea powder. The infusion bag may be made of one or more nonwoven fabrics. The fabric may be selected to contain the green tea powder within the infusion bag when the infusion bag containing the green tea pieces and green tea powder is immersed in water. Alternatively, the fabric may be selected to retain the green tea leaf pieces within the infusion bag while allowing the green tea leaf powder to pass through the infusion bag when the infusion bag is placed in a liquid. The one or more nonwoven fabrics may have a mass per unit area ranging from about 15 g/m² to about 30 g/m². The one or more nonwoven fabrics may also have a ventilation rate ranging from about 150 ml/cm-sec to about 450 ml/cm-sec, and a filtering rate of about 1.5 sec/500 ml to about 2.5 sec/500 ml.

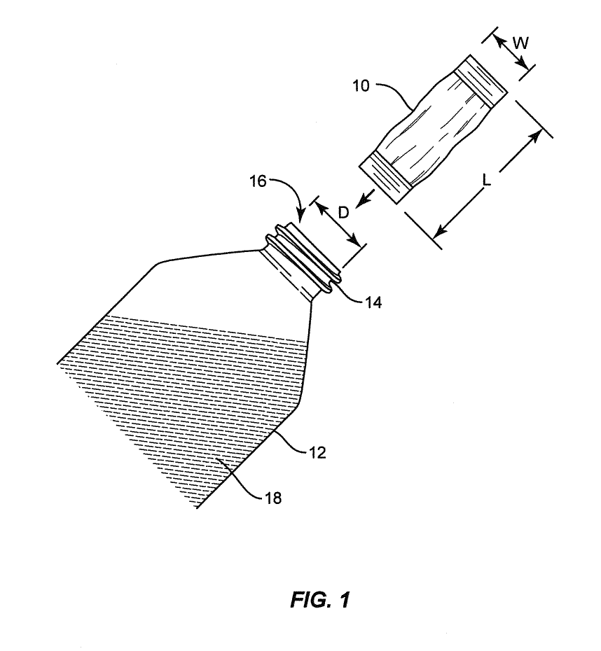

In various embodiments, the infusion bag may be sized such that it may be readily inserted through the mouth of a standard plastic water bottle. FIG. 1 illustrates a water bottle 12 having a mouth 14. An opening 16 of the mouth 14 has a diameter D. The bottle 12 may contain a liquid 18, such as water, at a temperature less than or equal to about 10° C. The bottle 12 may range in size from about 0.5 liter to about 2 liters, although other sizes may also be applicable. Plastic bottles 12 of this general size range typically have a mouth opening 16 with a diameter D of about 28 mm. Thus, an infusion bag 10 may be sized so that it may be inserted through the mouth opening 16 without undue folding, compressing, or compacting. In one embodiment, the infusion bag 10 has a width W of about 25 mm. The width W of the infusion bag 10 may range from about 20 mm to about 40 mm in various other embodiments.

A length L of the infusion bag 10 may be sized such that the infusion bag 10 contains an amount of the green tea leaf pieces and green tea powder mixture appropriate for the volume of liquid in the bottle 12. In at least one embodiment, the infusion bag 10 has a length L of about 80 mm. The length L of the infusion bag may range from about 60 mm to about 100 mm in various other embodiments.

As used herein, the terms “green tea leaf,” “green tea leaves,” and “green tea powder” are understood to refer to any part or combination of parts of a green tea plant. Thus, the present invention may be comprised of pieces and powder of any combination of parts of the green tea plant, including but not limited to the leaves, stems, branches, roots, seeds, flowers, pods, and the like.

The present invention may include other ingredients, in any combination, in addition to green tea leaf pieces and green tea leaf powder. These other ingredients may include, but are not limited to, flavorings, preservatives, fillers, tea other than green tea, stimulants, fruit or fruit extracts, herbs, spices, sugar and other natural and artificial sweeteners, colorants, antioxidants, vitamins, minerals, nutrients, acidity regulators, antifoaming agents, emulsifiers, stabilizers, thickeners, energy enhancers, and the like.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

### Example

Ten panelists having experience in the taste and color qualities of green tea were assembled. A mixture of green tea pieces having a size of about 3 mm and green tea powder having a size of about 30 μm was prepared. The ratio of green tea pieces to green tea powder was about 4:1. The mixture of green tea pieces and green tea powder was placed in an infusion bag. Ten green tea beverages were prepared by placing the infusion bags in a bottle of cold water and shaking. The temperature of the cold water was about 10° C. The bottles were shaken for the following times: 0.5 minute, 1.0 minute, 1.5 minutes, 2.0 minutes, 2.5 minutes, 3.0 minutes, 3.5 minutes, 4.0 minutes, 4.5 minutes, and 5.0 minutes. Each panelist sampled each of the ten green tea beverages and rated the taste and color. The taste was ranked on a scale of 1 to 5, with a ranking of at least 2.5 indicating a satisfactory taste, and a ranking of at least 4.0 indicating a high-quality taste. The color was also ranked on a scale of 1 to 5, with a ranking of at least 3.0 indicating a satisfactory color, and a ranking of at least 3.5 indicating a rich, bold color. The rankings of the ten panelists were averaged for each sample.

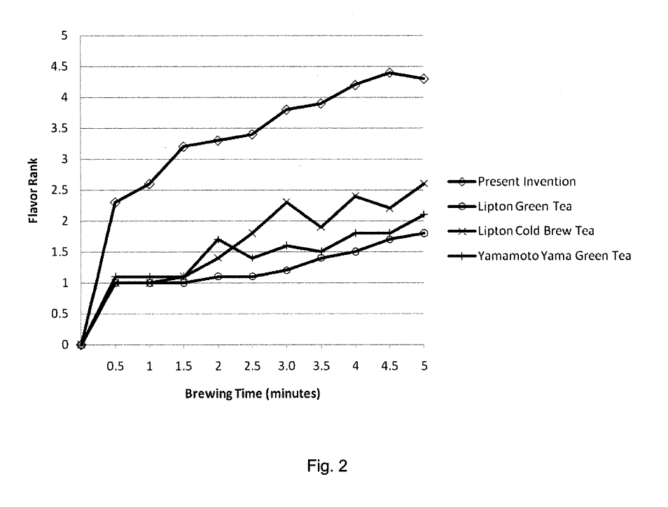

The above experiment was repeated with three commercially available tea products: Lipton Green Tea Bags, Lipton Cold Brew Ice Tea Bags, and Yamamoto Yama Green Tea Bags. FIG. 2 illustrates a graph of the average taste rankings for each of the green tea samples. The present invention produced a satisfactory tasting (average ranking of about 2.5) cold-brew tea beverage in about 0.5 minute. Neither the Lipton Green Tea Bag nor the Yamamoto Yama Green Tea Bag could achieve an average ranking above about 2.1 after 5 minutes. The Lipton Cold-Brew Ice Tea Bag required about 5 minutes to achieve a satisfactory tasting beverage, 9 times longer than the present invention.

The present invention achieved a high-quality taste (average ranking of at least 4.0) after about 2.5-3.0 minutes. None of the other tea products achieved a taste ranking above 2.6 after 5 minutes.

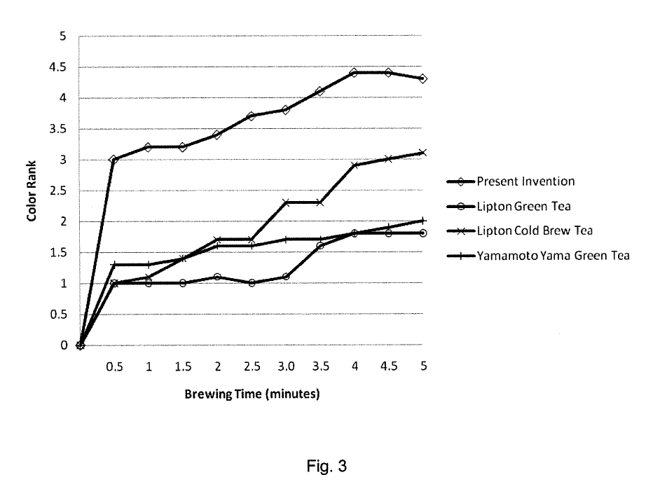

FIG. 3 illustrates a graph of the average color rankings for each of the green tea samples. The present invention produced a green tea beverage with a satisfactory color (ranking of at least 3.0) after about 0.5 minute. Neither the Lipton Green Tea Bag nor the Yamamoto Yama Green Tea Bag could achieve an average ranking above 2.0 after 5 minutes. The Lipton Cold-Brew Ice Tea Bag required about 4.5 minutes to achieve a satisfactory tasting beverage, 9 times longer than the present invention.

The present invention achieved a rich, bold color (average ranking of at least 3.5) in about 2.0-2.5 minutes. None of the other tea products achieved an average color ranking above 3.1 after 5 minutes.

What is claimed is:

1. A cold-brew green tea composition, comprising:
a mixture of green tea leaf pieces ranging in size from about 2 millimeters to about 6 millimeters and powdered green tea leaves ranging in size from about 20 micrometers to about 40 micrometers, in a ratio of green tea leaf pieces to green tea leaf powder of about 2:1 to about 10:1, the mixture when mixed in water having a temperature less than or equal to about 10° C. produces a concentration of catechins in the water ranging from about 0.1 milligrams/milliliter to about 0.8 milligrams/milliliter after about 1 minute of mixing.

2. The cold-brew green tea composition of claim 1, wherein the catechins are polyphenol catechins.

3. The cold-brew green tea composition of claim 2, wherein the polyphenol catechin is epigallocatechin gallate.

4. The cold-brew green tea composition of claim 1 further comprising one or more ingredients selected from flavorings, preservatives, fillers, tea other than green tea, stimulants, fruit or fruit extracts, herbs, spices, sugar and other natural and artificial sweeteners, colorants, antioxidants, vitamins, minerals, nutrients, acidity regulators, antifoaming agents, emulsifiers, stabilizers, thickeners, energy enhancers, and combinations thereof.

5. The cold-brew green tea composition of claim 1, wherein the mixture when mixed in water having a temperature less than or equal to about 10° C. produces a satisfactory color and taste after about 1 minute of mixing.

6. The cold-brew green tea composition of claim 1, wherein a portion of the green tea leaf pieces is roasted.

7. The cold-brew green tea composition of claim 6, wherein the portion of roasted green tea leaf pieces is approximately half of the green tea leaf pieces.

8. The cold-brew green tea composition of claim 1, further comprising an infusion bag for containing the green tea composition when the green tea composition is mixed in water, the infusion bag comprising:
at least one nonwoven fabric having a mass per unit area of about 15 grams/square meter to about 30 grams/square meter, a ventilation rate of about 150 milliliters/centimeter-second to about 450 milliliters/centimeter-second, and a filtering rate of about 1.5 seconds/500 milliliters to about 2.5 seconds/500 milliliters; and
a width ranging from about 20-40 millimeters to allow the infusion bag to be readily inserted through a mouth of a standard water bottle.

9. A method for preparing a cold-brew green tea beverage, comprising:
preparing green tea leaf pieces by reducing green tea leaves into pieces;
preparing green tea leaf powder by reducing green tea leaves into particles;
combining the green tea leaf pieces and green tea leaf powder in a ratio ranging from about 2:1 to about 10:1 to form a green tea mixture; and
contacting the green tea mixture with water having a temperature less than or equal to about 10° C. for about 1 minute to produce a concentration of catechins in the water ranging from about 0.1 milligrams/milliliter to about 0.8 milligrams/milliliter.

10. The method of claim 9, wherein the green tea leaf pieces range in size from about 2 millimeters to about 6 millimeters.

11. The method of claim 9, wherein the green tea powder particles range in size from about 20 micrometers to about 40 micrometers.

12. The method of claim 9, further comprising contacting the green tea mixture with water having a temperature less than or equal to about 10° C. for about 1 minute to produce a satisfactory taste and color of the cold-brew green tea beverage.

13. The method of claim 9, wherein contacting the green tea mixture with water comprises contacting an infusion bag containing the green tea mixture with water, the infusion bag comprising:
at least one nonwoven fabric having a mass per unit area of about 15 grams/square meter to about 30 grams/square meter, a ventilation rate of about 150 milliliters/centimeter-second to about 450 milliliters/centimeter-second, and a filtering rate of about 1.5 second/500 milliliters to about 2.5 seconds/500 milliliters; and
a width ranging from about 20 millimeters to about 40 millimeters to allow the infusion bag to be readily inserted through a mouth of a standard water bottle.

14. An infusion bag for cold brewing green tea, comprising:
at least one nonwoven fabric having a mass per unit area of about 15 grams/square meter to about 30 grams/square meter, a ventilation rate of about 150 milliliters/centimeter-second to about 450 milliliters/centimeter-second, and a filtering rate of about 1.5 seconds/500 milliliters to about 2.5 seconds/500 milliliters;
a width ranging from about 20 millimeters to about 40 millimeters to allow the bag to be readily inserted through the mouth of a standard water bottle;
a length selected to provide a green tea capacity sufficient to produce a cold-brew green tea beverage of satisfactory taste after a period of 1 minute of mixing the infusion bag with water having a temperature less than or equal to about 10° C. in the water bottle.

15. The infusion bag of claim 14, wherein the length ranges from about 60 millimeters to about 100 millimeters.

16. The infusion bag of claim 14, wherein the green tea capacity ranges from about 1 gram to about 5 grams.

17. The infusion bag of claim 14, wherein the green tea capacity ranges from about 1 gram to about 5 grams of a mixture of green tea pieces and green tea powder, the green tea pieces ranging in size from about 2 millimeters to about 6 millimeters and the green tea powder ranging in size from about 20 micrometers to about 40 micrometers, the ratio of green tea pieces to green tea powder in the mixture ranging from about 2:1 to about 10:1.

18. A green tea cold brewing system, comprising:
an infusion bag made of at least one nonwoven fabric having a mass per unit area of about 15 grams/square meter to about 30 grams/square meter, a ventilation rate of about 150 milliliters/centimeter-second to about 450 milliliters/centimeter-second, and a filtering rate of about 1.5 seconds/500 milliliters to about 2.5 seconds/500 milliliters;
wherein the infusion bag is shaped to be readily inserted into a mouth of a standard water bottle; and
green tea leaf pieces ranging in size from about 2 millimeters to about 6 millimeters mixed in a ratio of about 2:1 to about 10:1 with green tea powder ranging in size from about 20 micrometers to about 40 micrometers.

19. The green tea cold brewing system of claim 18, wherein a width of the infusion bag ranges from about 20 millimeters to about 40 millimeters.

20. The green tea cold brewing system of claim 18, wherein a cold-brew green tea beverage is produced by contacting the green tea cold brewing system with water at a temperature less than or equal to about 10° C. for about 1 minute, thereby establishing a catechin concentration in the cold-brew green tea beverage ranging from about 0.1 milligrams/milliliter to about 0.8 milligrams/milliliter.
